(19) United States
(12) Patent Application Publication
(10) Pub. No.: US 2004/0042760 A1
(43) Pub. Date: Mar. 4, 2004

(54) Device for controlling viewing of video programs for video appliances

(76) Inventor: Seok Hwa Jeong, Kyoungsangbuk-Do (KR)

Correspondence Address: Oppenheimer Wolff & Donnelly LLP, Suite 700, 233 Wilshire Blvd., Santa Monica, CA, 90401, US

(21) Appl. No.: 10/420,672

(22) Filed: Apr. 21, 2003

Related U.S. Application Data
(63) Continuation-in-part of application No. 08/889,621, filed on Jul. 8, 1997, now abandoned.

(30) Foreign Application Priority Data
Jul. 10, 1996 (KR) P96-27736
Jul. 10, 1996 (KR) P96-27737

(51) Int. Cl. H04N 5/76; H04N 5/781

(52) U.S. Cl. 386/46; 386/125; 386/126

(57) ABSTRACT

A device for controlling viewing of a video program for video appliances capable of grading adult programs of violence and sex distributed through diverse video media and restricting juveniles' viewing of those programs. In recording, a viewing-restriction step (grade) is determined in accordance with the contents of a video program to be recorded, and the video program provided from one of the video appliances is recorded on a recording medium in accordance with the determined record control step. In reproduction, the record control step of the video program recorded on the recording medium is recognized, and then compared with a reproduction control step determined at the reproduction stage, so that the reproduction of the video program is selectively performed depending on the comparison result of the record control step and the reproduction control step.

This application is a continuation-in-part application of U.S. patent application Ser. No. 08/889,621, filed Jul. 10, 1997, and now abandoned, which claims priority under the International Convention from Korean Application No. P96-27736 filed Jul. 10, 1997, and Korean Application No. P96-27737 filed Jul. 10, 1997.

### BACKGROUND OF THE INVENTION

1. Field of the Invention

The present invention relates to a device for controlling viewing of video programs for video appliances which can guide juveniles to a sound direction by determining a record control step and a reproduction control step for video programs and restricting juveniles, viewing of adult programs of violence and sex distributed through diverse video media.

2. Description of the Related Art

Diverse video media have appeared with popularity. Programs manufactured in various forms are distributed to general consumers without undergoing an austere censorship.

It is currently possible for anyone to view video programs prohibited to juveniles through diverse video reproducing appliances. The most common practice to prohibit such viewing is to distinguish the video programs for adults and for juveniles by simply labeling on the case of video media.

Under these circumstances, the video programs containing unsound or undesirable contents are exposed and conveyed to juveniles without being filtered. This harms juveniles' mental health and causes deviant behavior.

### SUMMARY OF THE INVENTION

It is an object of the present invention to solve the aforementioned problems, and to provide a device for controlling viewing of video programs for video appliances which can intercept randomly provided video programs that might adversely affect juveniles by determining a record control step according to the contents of the programs when recording the video programs and controlling recording of the video programs provided from video media according to the determined record control step.

It is another object of the present invention to provide a device for controlling viewing of video programs for video appliances which can selectively reproduce the programs through record control step according to the contents of the programs and reproduction control step according to the video appliance.

In one aspect of the present invention, there is provided a device for controlling viewing of video programs for video appliances comprising:

a deck section for placing therein a video data storage medium to be reproduced;

a determining section for determining a reproduction control step by an authorized user, the reproduction control step representing contents grading of the video program which can be reproduced in the video appliance;

a storage section for storing the reproduction control step determined by the authorized user;

a discriminating section for recognizing a record control step of the video program and the reproduction control step stored in the storage section and comparing the record control step with the reproduction control step, the record control step of the video program being recorded on the video data storage medium which is placed in the deck section;

a control section for determining whether to reproduce the video program in accordance with a comparison result from the discriminating section;

a change section for changing the reproduction control step stored in the storage section by the user if the record control step discords with the reproduction control step as a result of comparison with the discriminating section; and

a message generating section for notifying the user of the current reproduction control step stored in the storage section and the record control step of the video program.

In another aspect of the present invention, there is provided a device for controlling viewing of video programs for video appliances, comprising:

a deck section for placing therein a video data storage medium to be reproduced;

a determining section for determining a reproduction control step by a user, the reproduction control step representing contents grading of the video programs which can be reproduced in the video appliance;

a storage section for storing a reproduction control step determined by the determining section and an identification code of the user;

a program display section for displaying various kinds of video programs recorded on the video data storage medium;

a program selecting section for singly selecting a desired video program among the video programs displayed by the program display section;

a discriminating section for recognizing a record control step of the single video program selected by the program selecting section and comparing the record control step with the reproduction control step determined by the determining section;

a control section for determining whether to reproduce the selected video program in accordance with a comparison result from the discriminating section;

a change section for changing the reproduction control step stored in the storage section by the user if the record control step discords with the reproduction control step as a result of comparison with the discriminating section;

a coding section for receiving a user's input of an identification code, comparing the identification code inputted from the user with the identification code stored in the storage section, and qualifying the user to access the determining section or the change section if the identification codes are same each other; and

a message generating section for notifying the user of the current reproduction control step stored in the storage section and the record control step of the selected video program.

In still another aspect of the present invention, there is provided a home video recording and reproducing device that allows parents to grade video programs for recording on a video recording medium at different grading levels, and allows the parent to control access by children to playback of said video programs according to said grading levels, comprising:

a control section for controlling recording of a selected video program according to one of a plurality of record control steps in accordance with control signals generated from a control signal generating section of the control section;

a recording section for recording onto the recording medium the selected program and the control signals corresponding to the record control step, thereby to perform reproduction of the recorded program in accordance with the control signals corresponding to the control record control steps;

a determining section for determining a reproduction control step by the user, the reproduction control step representing contents grading of said video program which can be reproduced from the recording medium;

a discriminating section for recognizing a record control step of a video program recorded on the recording medium and comparing the record control step with the reproduction control step determined in the determining section;

a control section for determining whether to reproduce the video program in accordance with a comparison result from the discriminating section; and

a coding section for receiving a user's input of a predetermined code and qualifying the user to access the determining section in accordance with the inputted code.

In still another aspect of the present invention, there is provided a method of controlling viewing of video programs, comprising:

(a) detecting whether a video data storage medium is placed in a deck section of a video appliance;

(b) reading a record control step of a video program recorded on the video data storage medium placed in the deck section;

(c) reading a reproduction control step of the video appliance, the reproduction control step being stored in a storage section of the video appliance;

(d) comparing the record control step of the video program with the reproduction control step;

(e) reproducing the video program if the record control-step accords with the reproduction control step; and

(f) changing the reproduction control step by a user if the video control step does not accord with the reproduction control step.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram of the device for selectively recording video programs for video appliances according to the present invention.

FIG. 2 is a block diagram of the device for controlling viewing of a video program for video appliances according to one embodiment of the present invention.

FIG. 3 is a block diagram of the device for controlling viewing of a video program for video appliances according to another embodiment of the present invention.

FIG. 4 is a block diagram of the device for controlling viewing of a video program for video appliances according to still another embodiment of the present invention.

FIG. 5 illustrates a table explaining record/reproduction control steps according to the viewing grades according to the present invention.

### DETAILED DESCRIPTION OF THE PREFERRED EMBODIMENTS

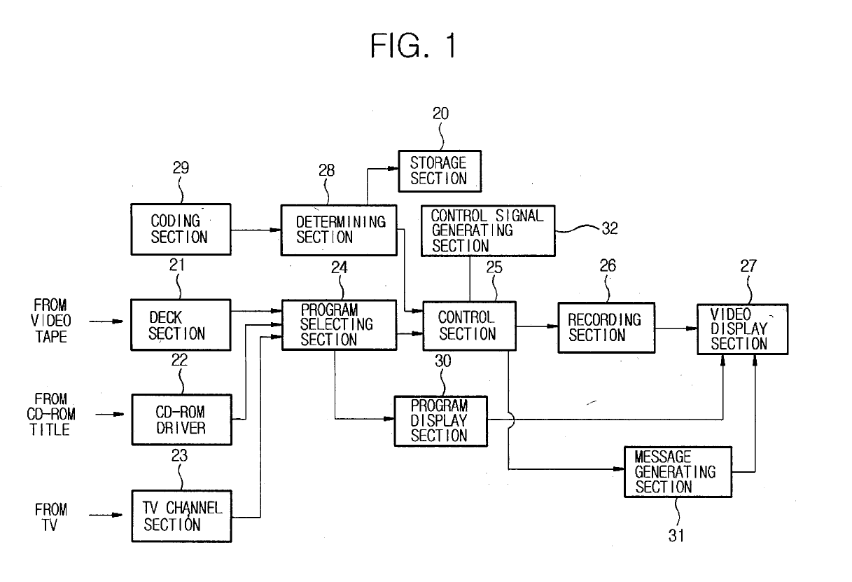

FIG. 1 is a block diagram of the device for selectively recording video programs for video appliances according to the present invention. Referring to FIG. 1, the recording device according to the present invention includes a program selecting section 24 for selecting one of video programs outputted from video appliances 21, 22, 23, a control section 25 for controlling recording of the program selected by the program selecting section 24 with a series of recording control steps, a recording section 26 for recording the selected program in accordance with the series of recording control steps under the control of the control section 25, and a video/audio output section 27 for outputting video and audio signals of the program recorded by the recording section 26.

The control section 25 determines three viewing-restriction steps (grades) of programs, such as for adults only, for adults and juveniles (general audience), and for juveniles only, and controls the recording of the program to be performed according to the determined viewing-restriction steps (grades).

The selective recording device according to the present invention further includes a control signal generating section 32 for generating control signals which are distinguished by a pulse or a combination of pulses, or inherent control signals, so that the control section 25 controls the recording section 26 to record the control signals so as for the control section to recognize the viewing-restriction steps (grades), a determining section 28 for determining the viewing-restriction steps (grades) of the programs to be recorded; a storage section 20 for storing the viewing-restriction step determined by the determining section 28; a coding section 29 for enabling/disabling the determining section 28 to determine the viewing-restriction steps (grades), a program display section 30 for receiving data from the program selecting section 24 and displaying the title and contents of the currently recorded program through the video/audio output section 27, and a message generating section 31 for receiving data from the control section 25 and displaying the state of the currently recorded program through the video/audio output section to notify the viewer of the state of the program.

In the embodiments, diverse video appliances connected to the program selection section 24 are a video deck section 21 in which the video data storage medium, such as a video tape, is placed, a CD-ROM driver 22 in which a CD-ROM title is placed, and a TV channel section 23 for receiving a TV broadcasting signal. Also, the video appliance connected to the program selection section 24 may be a PVR (Private Video Recorder) in which a hard disk is installed.

The operation of the selective recording device according to the present invention will now be explained. A user who is an adult such as a parent or a guardian may input a code determined in the form of particular letters or numbers through the coding section 29 before recording a video medium to subsequently prevent a juvenile or a third person from arbitrarily manipulating the device.

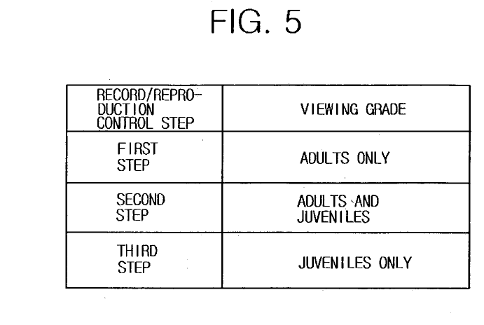

If the code is inputted as described above, the determining section 28 becomes ready to determine the record control step that may be the inputted code itself or an encoded form of the code. As illustrated in FIG. 5, one of the three steps should be determined according to the viewing object, i.e., viewing grade of the program.

After the determination of the record control step is completed, one of the video appliances may be selected to record the corresponding video program. For instance, a video deck section 21 in which a video tape is placed is connected if a video cassette recorder is selected, while a CD-ROM driver 22 is connected if a CD-ROM title is selected. Also, a TV channel section 23 is connected if a TV is selected.

If one of the video appliances 21, 22, 23 is selected and a corresponding program to be recorded is selected by the program selecting section 24, the control section 25 controls the recording section 26 to record the program according to the record control steps determined by the determining section 28.

The program being recorded by the recording section 26, is simultaneously displayed through the video/audio output section 27, while the title or the contents of the recorded program is also displayed through the video/audio output section 27 by the program display section 30.

As illustrated in FIG. 5, the record control steps controlled by the control section 25 may be classified into a first step for programs for adults only; a second step for programs for both adults and juveniles; and a third step for programs for juveniles only. In other words, a first step is determined for the programs that adults can exclusively watch, a second step is determined for the programs that are close to those for adults but not harmful so that adults (parents) and juveniles can watch together, and a third step is determined for the programs that are included in neither first nor second step programs and juveniles can exclusively watch.

If a user determines the first step through the determining section 28, the control signal produced by a pulse or a combination of pulses, or the inherent control signal corresponding to the step for a program for adults only is recorded in the recording medium together with the program itself by the recording section 26, so that the control signal can be recognized when the recorded program is reproduced. In other words, to distinguish the record control steps, a control signal formed by a pulse or a combination of pulses, or an inherent control signal is generated from the control signal generating section 32 corresponding to the record control step of the program to be recorded and is recorded on the recording medium together with the program. Particular control signals corresponding to the second and third steps will be recorded on the recording medium in the same manner as the first step. Here, in order to distinguish the control steps, it may be also preferable that the control signal generating section 32 generates inherent control signals.

The control section 25 also controls the message generating section 31 to display the recording control step through the video display section 27, so that the user can recognize the record control step of the recorded program.

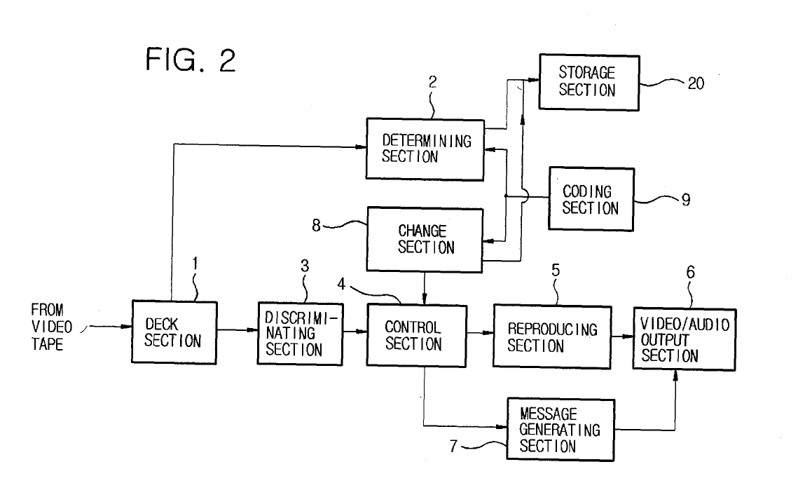

FIG. 2 is a block diagram of the device for controlling viewing of a video program for video appliances according to one embodiment of the present invention.

Referring to FIG. 2, the device according to the present invention includes a deck section 1 for placing therein a video data storage medium, such as a video tape, to be reproduced, a determining section 2 for determining a reproduction control step by a user, the reproduction control step representing contents grading of the video programs which can be reproduced in the video appliance, a storage section 20 for storing the reproduction control step determined by the user, a discriminating section 3 for recognizing a record control step of the video program being recorded on the video data storage medium placed in the deck section 1 and the reproduction control step stored in the storage section, and comparing the recognized record control step with the reproduction control step, a control section 4 for determining whether to reproduce the video program according to the comparison result from the discriminating section 3, a reproducing section 5 for reproducing, the video program recorded on the video data storage medium under the control of the control section 4, a video/audio output section 6 for outputting video and audio signals of the video program reproduced by the reproducing section 5, and a message generating section 7 for notifying a user of the, current reproduction control step of the video program reproduced by the reproducing section 5 through the video/audio output section 6 under the control of the control section 4.

The device according to the present invention further includes a change section 8 for changing the reproduction control step stored in the storage section by the user if the record control step discords with the reproduction control step as a result of comparison with the discriminating section 3. The change section 8 changes the reproduction control step as explained in more detail below. The device according to the present invention further includes a coding section 9 for receiving a user's input of an identification code, comparing the identification code inputted from the user with the identification code stored in the storage section, and qualifying the user to access the determining section 2 or the change section 8 if the identification codes are identical with each other so that a juvenile or a third party may not arbitrarily manipulate the device.

According to the device according to one embodiment of the present invention, the video data storage medium placed in the deck section 1 is reproduced with a series of reproduction control steps, so that reproduction is selectively performed depending on the record control step of the video program being recorded on the video data storage medium.

If the user inputs a code determined in the form of particular letters or numbers through the coding section 9, the determining section 2 operates to determine the reproduction control steps.

As illustrated in FIG. 5, the reproduction control steps inputted by the user through the determining section 2 are classified into three steps: 1) for programs for adults only, 2) for adults and juveniles, and 3) for juveniles only, as in the record control steps as described above.

The discriminating section 3 compares the input code with the determined code by the determining section. If the two codes correspond to each other as a result of comparison, the control section 4 transfers the video program signal read out from the video data storage medium to the reproducing section 5.

The video program reproduced as described above is outputted through the video/audio output section 6 for user's viewing. When the video and audio signals of the reproduced video program are outputted, the control section 4 notifies the user of the reproduction control step of the video program being reproduced.

However, if the record control step of the currently video data storage medium placed in the deck section 1 does not correspond to the reproduction control step stored in the storage section 20,the control section 4 prevents the reproducing section 5 from reproducing the recorded program, and notifies the user through the message generating section 7 and the video/audio output section 6 that the video data storage medium cannot be reproduced due to the determined record control step.

If the use changes through the change section 8 the reproduction control step to correspond to the record control step of the video program to be reproduced, the control section 4 re-recognizes the changed reproduction control step and allows the reproducing section 5 to reproduce the recorded video program.

As illustrated in FIG. 5, determination of the reproduction control step to be the first step enables reproduction of the program for adults only. Determination of the reproduction control step to be the second step enables reproduction of the program for adults and juveniles.

Determination of the reproduction control step to be the third step enables reproduction of the program for juveniles only.

For instance, if a reproduction control step has been determined to be the third step so that juveniles may not view the programs for adults only, the juveniles will be unable to reproduce and view the video data storage medium in which the program for adults only has been recorded. Further, the juveniles will be unable to change the reproduction control step through the change section 8 unless they know the particular code.

No problem arises when only one program has been recorded on one video data storage medium, such as a video tape. When a plurality of programs have been recorded on one video tape, especially when the programs for adults only and juveniles only have been recorded on one video tape, however, it will be inconvenient for user's viewing. To solve this problem, another embodiment of the present invention has been proposed.

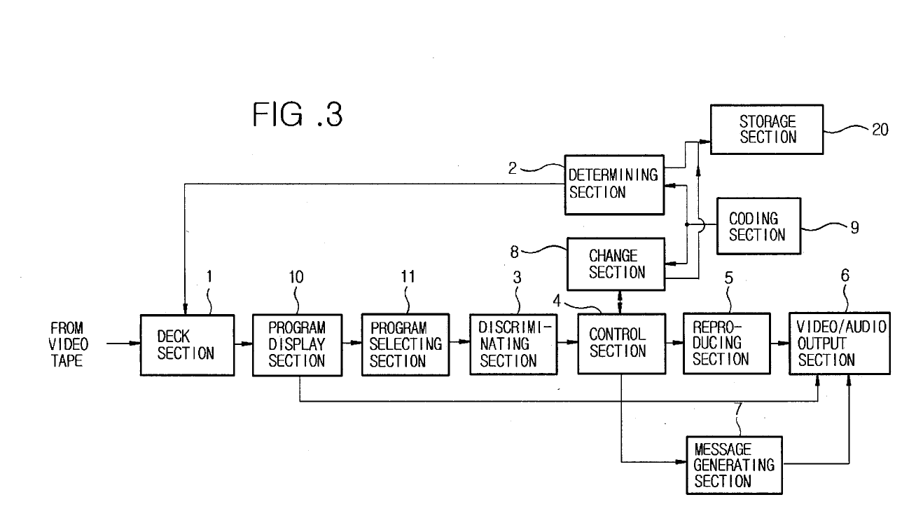

The construction and effect of the device for controlling viewing of a video program for video appliances, according to another embodiment of the present invention will now be explained with reference to FIG. 3. The parts overlapping with the first embodiment will be referred to by the same reference numerals whose descriptions are omitted from the following explanation.

Referring to FIG. 3, the device for controlling viewing of a video program for video appliances according to another embodiment of the present invention includes a deck section 1 in which a video data storage medium, such as a video tape, is placed, a determining section 2 for determining a reproduction control step of the video data storage medium placed in the deck section 1, a storage section 20 for storing the reproduction control step determined by a user using the determining section 2, a discriminating section 3 for recognizing the record control step of the program recorded on the video data storage medium in the deck section 1 and comparing the recognized record control step with the reproduction control step determined by a user, a control section 4 for determining whether to reproduce the program in accordance with the comparison result from the discriminating section 3, a reproducing section 5 for reproducing the program recorded on the video data storage medium under the control of the control section 4, a video/audio output section 6 for outputting video and audio signals of the program reproduced by the reproducing section 5, and a message generating section 7 for notifying the user of the current reproduction control step of the program reproduced by the reproducing section 5 through the video/audio output section 6 under the control of the control section 4.

The device according to another embodiment of the present invention further includes a change section 8 for changing or verifying the reproduction control step. Specifically, if the record control step obtained from the recorded program in the video data storage medium does not correspond to the reproduction control step determined by the user through the determining section 2, the change section 8 changes the reproduction control step as explained in more detail below. The device further includes a coding section 9 for qualifying the determining section 2 and the change section 8 to determine the reproduction control step so that a juvenile or a third party may not arbitrarily manipulate the device, a program display section 10 for displaying a plurality of programs which have been recorded on the video data storage medium in the deck section 1 through the video/audio output section 6, and a program selecting section 11 for selecting a desired video program among the video programs displayed through the video program display section 10.

According to the device according to the second embodiment, if a video data storage medium, such as a video tape, in which a plurality of programs of different grades are recorded is placed in the deck section 1, the program display section 10 displays the programs recorded on the video data storage medium through the video/audio output section 6.

If the user selects a desired video program through the program selecting section 11 among the video programs displayed by the video/audio output section 6, the discriminating section 3 compares the reproduction control step determined by the first determining section 2 with the record control step determined and recorded on the video data storage medium, and discriminates whether the two steps accord with each other for the selective reproduction as described in the first embodiment.

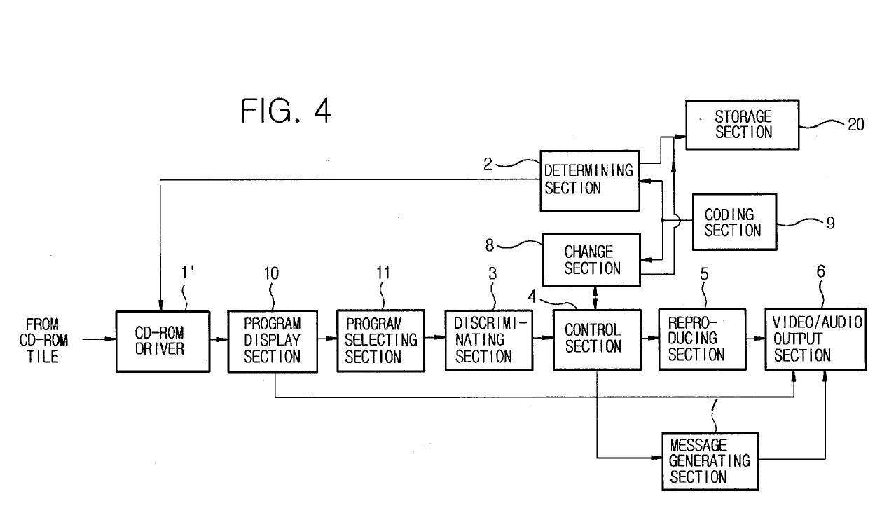

FIG. 4 is a block diagram of the device for controlling viewing of a video program for video appliances according to still another embodiment of the present invention. The construction and effect of this embodiment is the same as those of the second embodiment described above.

According to this embodiment, if a optical storage medium, such as a CD-ROM title and a DVD (digital video disc) is placed in a optical storage driver, such as a CD-ROM driver 1′, a plurality of programs contained in the optical storage medium is reproduced and displayed through the video/audio output section 6. If the user selects a desired video program among the recorded video programs, the record control step of the video program contained in the optical storage medium is compared with the reproduction control step determined by the determining section 2 for selective reproduction.

As described above, according to the three embodiments of the present invention, the record control step of the selected video program is recognized, and the reproduction control step for selective reproduction is determined depending on the viewing object. Thus, a selective reproduction of a video medium is performed according to the determined reproduction control step.

From the foregoing, the present invention provides a device for controlling viewing of video programs which can restrict viewing of the program that may harm mental health of juveniles and thus serve for mental health and sound culture of the juveniles by selectively recording and reproducing a video program depending on the viewing grade thereof.

While the present invention has been described and illustrated herein with reference to the preferred embodiments thereof, it will be understood by those skilled in the art that various changes in form and details may be made therein without departing from the spirit and scope of the invention.

What is claimed is:

1. A device for controlling viewing of a video program for video appliances, comprising:
a deck section for placing therein a video data storage medium to be reproduced;
a determining section for determining a reproduction control step by an authorized user, the reproduction control step representing contents grading of the video program which can be reproduced in the video appliance;
a storage section for storing the reproduction control step determined by the authorized user;
a discriminating section for recognizing a record control step of the video program and the reproduction control step stored in the storage section and comparing the record control step with the reproduction control step, the record control step of the video program being recorded on the video data storage medium which is placed in the deck section;
a control section for determining whether to reproduce the video program in accordance with a comparison result from the discriminating section;
a change section for changing the reproduction control step stored in the storage section by the user if the record control step discords with the reproduction control step as a result of comparison with the discriminating section; and
a message generating section for notifying the user of the current reproduction control step stored in the storage section and the record control step of the video program.

2. A device for controlling viewing of video programs for video appliances, comprising:
a deck section for placing therein a video data storage medium to be reproduced;
a determining section for determining a reproduction control step by a user, the reproduction control step representing contents grading of the video programs which can be reproduced in the video appliance;
a storage section for storing the reproduction control step determined by the determining section and an identification code of the user;
a program display section for displaying various kinds of video programs being recorded on the video tape;
a program selecting section for singly selecting a desired video program among the video programs displayed by the program display section;
a discriminating section for recognizing a record control step of the video program selected by the program selecting section and comparing the record control step with the reproduction control step stored in the storage section;
a control section for determining whether to reproduce the selected video program in accordance with a comparison result from the discriminating section;
a change section for changing the reproduction control step being stored in the storage section by the user if the record control step discords with the reproduction control step as a result of comparison with the discriminating section; and
a coding section for receiving a user's input of an identification code, comparing the identification code inputted from the user with the identification code stored in the storage section, and qualifying the user to access the determining section or the change section if the identification codes are identical with each other.

3. A device for controlling viewing of video programs for video appliances, comprising:
a deck section for placing therein a video data storage medium to be reproduced;
a determining section for determining a reproduction control step by a user, the reproduction control step representing contents grading of the video programs which can be reproduced in the video appliance;
a storage section for storing a reproduction control step determined by the determining section and an identification code of the user;
a program display section for displaying various kinds of video programs recorded on the video data storage medium;
a program selecting section for singly selecting a desired video program among the video programs displayed by the program display section;
a discriminating section for recognizing a record control step of the single video program selected by the program selecting section and comparing the record control step with the reproduction control step determined by the determining section;
a control section for determining whether to reproduce the selected video program in accordance with a comparison result from the discriminating section;
a change section for changing the reproduction control step stored in the storage section by the user if the record control step discords with the reproduction control step as a result of comparison with the discriminating section;
a coding section for receiving a user's input of an identification code, comparing the identification code inputted from the user with the identification code stored in the storage section, and qualifying the user to access the determining section or the change section if the identification codes are same each other; and
a message generating section for notifying the user of the current reproduction control step stored in the storage section and the record control step of the selected video program.

4. A device for controlling viewing of video programs for video appliances, comprising:
a optical storage driver for placing therein a optical storage medium to be reproduced;
a determining section for determining a reproduction control step by a user, the reproduction control step representing contents grading of the video programs which can be reproduced in the video appliance;
a storage section for storing a reproduction control step determined by the determining section and an identification code of the user ;
a program display section for displaying various kinds of video programs recorded on the optical storage medium;
a program selecting section for singly selecting a desired video program among the video programs displayed by the program display section;
a discriminating section for recognizing a record control step of the video program selected by the program selecting section and comparing the record control step with the reproduction control step stored in the storage section;
a control section for determining whether to reproduce the selected video program in accordance with a comparison result from the discriminating section;
a change section for changing the reproduction control step stored in the storage section by the user if the record control step discords with the reproduction control step as a result of comparison with the discriminating section,
a coding section for receiving a user's input of an identification code, comparing the identification code inputted from the user with the identification code stored in the storage section, and qualifying the user to access the determining section or the change section if the identification codes, are identical with each other;
a reproducing section for reproducing the single video program recorded on the optical storage medium under the control of the control section; and
a video/audio output section for outputting video and audio signals of the single video program reproduced by the reproducing section.

5. A device for controlling viewing of video programs for video appliances, comprising:
a optical storage driver for placing therein a optical storage medium to be reproduced;
a determining section for determining a reproduction control step by a user, the reproduction control step representing contents grading of the video programs which can be reproduced in the video appliance;
a storage section for storing a reproduction control step determined by the determining section and an identification code of the user;
a program display section for displaying various kinds of video programs recorded on the optical storage medium;
a program selecting section for singly selecting a desired video program among the video programs displayed by the program display section;
a discriminating section for recognizing a record control step of the video program selected by the program selecting section and comparing the record control step with the reproduction control step stored in the storage section;
a control section for determining whether to reproduce the selected video program in accordance with a comparison result from the discriminating section;
a change section for changing the reproduction control step stored in the storage section by the user if the record control step discords with the reproduction control step as a result of comparison with the discriminating section;
a coding section for receiving a user's input of an identification code, comparing the identification code inputted from the user with the identification code stored in the storage section, and qualifying the user to access the determining section or the change section if the identification codes are identical with each other; and
a message generating section for notifying the user of the current reproduction control step stored in the storage section and the record control step of the selected video program.

6. A home video recording and reproducing device that allows parents to grade video programs for recording on a video recording medium at different grading levels, and allows the parent to control access by children to playback of said video programs according to said grading levels, comprising:
a control section for controlling recording of a selected video program according to one of a plurality of record control steps in accordance with control signals generated from a control signal generating section of the control section;
a recording section for recording onto the recording medium the selected program and the control signals corresponding to the record control step, thereby to perform reproduction of the recorded program in accordance with the control signals corresponding to the control record control steps;
a determining section for determining a reproduction control step by the user, the reproduction control step representing contents grading of said video program which can be reproduced from the recording medium;
a discriminating section for recognizing a record control step of a video program recorded on the recording medium and comparing the record control step with the reproduction control step determined in the determining section;
a control section for determining whether to reproduce the video program in accordance with a comparison result from the discriminating section; and
a coding section for receiving a user's input of a predetermined code and qualifying the user to access the determining section in accordance with the inputted code.

7. A method of controlling viewing of video programs, comprising:
(a) detecting whether a video data storage medium is placed in a deck section of a video appliance;
(b) reading a record control step of a video program recorded on the video data storage medium placed in the deck section;
(c) reading a reproduction control step of the video appliance, the reproduction control step being stored in a storage section of the video appliance;
(d) comparing the record control step of the video program with the reproduction control step;
(e) reproducing the video program if the record control step accords with the reproduction control step; and
(f) changing the reproduction control step by a user if the video control step does not accord with the reproduction control step.

8. The method of claim 7, wherein the step (f) includes being inputted an identification code from the user, comparing the identification code inputted from the user with an identification code stored in a storage section of the video appliance, determining whether the identification codes accord with each other, and changing the reproduction control step by the user if the identification codes accord with each other.
